(19) United States
(12) Patent Application Publication
(10) Pub. No.: US 2015/0104635 A1
(43) Pub. Date: Apr. 16, 2015

(54) COATINGS FOR POLYOXYMETHYLENE POLYMER MOLDED ARTICLES

(71) Applicant: Ticona LLC, Florence, KY (US)

(72) Inventors: Jeremy H. Klug, Union, KY (US); Lowell J. Larson, Independence, KY (US); Yu Gao, Shanghai (CN)

(21) Appl. No.: 14/504,584

(22) Filed: Oct. 2, 2014

Related U.S. Application Data
(60) Provisional application No. 61/890,777, filed on Oct. 14, 2013.

(51) Int. Cl. C08J 7/04

(52) U.S. Cl. CPC C08J 7/042; C08J 2359/00; C08J 2433/06
USPC 428/323; 428/520; 428/483; 428/424.4; 427/412.1

(57) ABSTRACT

A coating system for polymer articles made from polyoxymethylene polymers is disclosed. The coating system can include a primer coat, a base coat, and a clear coat.

### RELATED APPLICATIONS

The present application is based on and claims priority to U.S. Provisional Patent application Ser. No. 61/890,777, filed on Oct. 14, 2013, which is incorporated herein by reference.

### BACKGROUND

Polyacetal polymers, which are commonly referred to as polyoxymethylene polymers, have become established as exceptionally useful engineering materials in a variety of applications. Polyoxymethylene polymers, for instance, are widely used in constructing molded parts, such as parts for use in the automotive industry and the electrical industry. Polyoxymethylene polymers have excellent mechanical properties, fatigue resistance, abrasion resistance, chemical resistance, and moldability.

Although polyoxymethylene polymers have excellent physical characteristics, the polymers are typically not amenable to many coating processes, such as printing or painting processes. For instance, due to a low surface energy and high crystallinity, polyoxymethylene polymers are not receptive to many paints and printing inks. Printing inks, for instance, do not sufficiently adhere to the surface of the polymer for many applications. While attempts have been made to pretreat the surface of the polymer to improve ink or paint adhesion, such as corona discharge, UV irradiation, or e-beam irradiation, followed by printing or painting, this requires additional time and is an added expense in the manufacturing of articles molded from polyoxymethylene polymers.

In addition to decorative coatings, problems have also been experienced in adhering functional coatings to polyoxymethylene polymers. Such coatings include, for instance, anti-glare or reflective coatings, ultraviolet light protective coatings, abrasion resistant coatings, and the like.

In view of the above, a need exists for a method of coating a molded article made from a polyoxymethylene polymer with a decorative or functional coating composition. In one embodiment, a need exists for a method of painting a molded substrate made from a polyoxymethylene polymer.

### SUMMARY

In general, the present disclosure is directed to a coating system for polymer articles. More particularly, the present disclosure is directed to a coating system for molded polymer articles made from a polyoxymethylene polymer. In one embodiment, the coating system can include a primer coat and optionally a base or color coat, and/or a top clear coat. Of particular advantage, the coating system of the present disclosure has been found to have excellent adhesion properties to the surface of a polyoxymethylene polymer.

In one embodiment, the present disclosure is directed to a molded article comprising a molded substrate made from a polyoxymethylene polymer. The polyoxymethylene polymer may comprise a copolymer. In one embodiment, the polyoxymethylene polymer may have hydroxyl functional groups. In still another embodiment, the molded substrate may be made from a polyoxymethylene polymer composition that contains a polyoxymethylene polymer coupled to a thermoplastic elastomer, such as a thermoplastic polyurethane elastomer.

In accordance with the present disclosure, a primer coat and optionally a base coat are applied to the surface of the molded substrate. The primer coat and the base coat can comprise an adhesion agent, optionally one or more pigments, optionally a dispersant, and a curing agent. The adhesion agent is present in each dried coating in an amount greater than 40% by weight, such as in an amount greater than 45% by weight, such as in an amount greater than 50% by weight, such as in an amount greater than 55% by weight, such as in an amount greater than 60% by weight, such as in an amount greater than about 65% by weight. The adhesion agent is present in the dried coatings in an amount less than about 90% by weight, such as in an amount less than about 85% by weight.

In one embodiment, the molded article may optionally also include a clear coat. The clear coat can cover the primer coat (where a base coat is not present) or it can cover the base coat. The clear coat can form an exterior surface on the molded article.

In one embodiment, the molded article includes a primer coat, a base coat, and a clear coat. At least one acrylic resin may be contained in each of the different coatings. The acrylic resin can be cured by the curing agent to form the coating. The primer coat can further include a coadhesive agent.

In order to provide color to the molded article, in one embodiment, the base coat contains one or more pigments. The pigments may be contained in the dried base coat in an amount greater than about 5% by weight, such as in an amount greater than about 8% by weight. For instance, one or more pigments may be contained in the base coat in an amount from about 5% to about 20% by weight, such as in an amount from about 5% to about 15% by weight.

In one embodiment, the adhesive agent is present in the base coat in an amount from about 50% to about 90% by weight, the pigment is present in the base coat in an amount from about 5% to about 20% by weight, a pigment dispersant is present in the base coat in an amount from 0.1% to 2% by weight, and a leveling agent is present in the base coat in an amount from about 0.05% to about 2% by weight.

In addition to producing a colored coating or decorative coating on the molded article, in other embodiments the coating may have a different function. For instance, the coating applied to the molded article may be to provide ultraviolet light stability, can provide abrasion resistance, can provide anti-glare or reflective properties, or may provide a combination of the above.

The present disclosure is also directed to a process for painting a molded article made from a polyoxymethylene polymer. In one embodiment, the process comprises the steps of applying to a surface of a polymer substrate a primer coat and a base coat. The primer coat and base coat comprise an adhesive agent, one or more pigments, a dispersant, and a curing agent. A clear coat is applied to cover the base coat and comprises an exterior surface of the molded article.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a molded article made from a polyacetal composition that has been coated in order to impart a color to at least a portion of the surface of the molded article or otherwise to protect the surface of the article. In one embodiment, multiple coatings are applied to a surface of the molded article in order to produce a multi-layer cured coating that has high hardness and low curing shrinkage. Of particular advantage, the coating system of the present disclosure has been found to have excellent adherence properties to the surface of a polyoxymethylene polymer.

In one embodiment, a solid-colored base coat is applied to a surface of a molded article made from a polyoxymethylene polymer over a primer coat. The solid-colored base coat contains one or more pigments and is heat cured. In accordance with the present disclosure, the particle size of the pigments within the base coat is controlled in order to eliminate the presence of large particles. The base coat is then covered with a clear coat. The clear coat can be applied as a two-component system. The first component can contain an adhesive agent while the second component can contain a curing agent, such as at least one polyisocyanate.

In addition to producing a colored coating on the molded article or instead of applying a colored coating to the surface of the molded article, in other embodiments, the coating may be applied to a surface of the molded article in order to have another function instead of being merely decorative. For instance, the coating may comprise a coating that is resistant to ultraviolet light. In another embodiment, the coating may provide the article with abrasion resistance. In still another embodiment, a coating may be applied to the molded article in accordance with the present disclosure in order to provide anti-glare or reflective properties. In most applications, a primer coat is first applied to a surface of the molded article. In certain embodiments, only a primer coat is applied to the molded article. In other embodiments, the coating system may include a primer coat and a base coat only, a primer coat and a clear coat only, or a primer coat, a base coat, and a clear coat.

When present, the primer coat is applied directly to the surface of the molded article meaning that there are no other layers or coatings in between the surface of the article and the primer coat. The primer coat can be positioned in between the surface of the molded article and the base coat or clear coat. In accordance with the present disclosure, the primer coat may contain the same adhesive agent as contained in the base coat or clear coat or an adhesive agent that is chemically similar to the adhesive agent contained in the base coat or clear coat. The primer coat can also contain a coadhesive agent.

In general, the molded polymer article may contain any suitable polyoxymethylene polymer. The polyoxymethylene polymer may comprise a polyoxymethylene homopolymer or a polyoxymethylene copolymer. In one particular embodiment, a polyoxymethylene copolymer is used that has a significant amount of functional groups, such as hydroxyl groups.

In one embodiment, the polyoxymethylene polymer comprises a polyoxymethylene copolymer that comprises an unbranched linear polymer which contains at least about 80%, such as at least about 90% of oxymethylene units.

In one embodiment, the preparation of the polyoxymethylene can be carried out by polymerization of polyoxymethylene-forming monomers, such as trioxane or a mixture of trioxane and dioxolane, in the presence of ethylene glycol as a molecular weight regulator. The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted. The above-described procedure for the polymerization can lead to polymers having comparatively small proportions of low molecular weight constituents. If a further reduction in the content of low molecular weight constituents were to be desired, this can be effected by separating off the low molecular weight fractions of the polymer after the deactivation and the degradation of the unstable fractions after treatment with a basic protic solvent. This may be a fractional precipitation from a solution of the stabilized polymer; polymer fractions of different molecular weight distribution being obtained.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. In one embodiment, the polyoxymethylene polymer has a content of terminal hydroxyl groups of at least 5 mmol/kg, such as at least 10 mmol/kg, such as at least 15 mmol/kg. In one embodiment, the terminal hydroxyl group content ranges from 18 to 50 mmol/kg.

In addition to the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

The polyoxymethylene polymer present in the composition can generally have a melt volume rate (MVR) of less than 50 cm³/10 min, such as from about 1 to about 40 cm³/10 min, such as from about 2 to 20 cm³/10 min determined according to ISO 1133 at 190° C. and 2.16 kg.

It is to be understood that the term polyoxymethylene comprises both homopolymers of formaldehyde or its cyclic oligomers, such as trioxane or 1,3,5,7-tetraoxacyclooctane, and corresponding copolymers. For example the following components can be used in the polymerization process: ethyleneoxide, 1,2-propyleneoxide, 1,2-butyleneoxide, 1,3-butyleneoxide, 1,3-dioxane, 1,3-dioxolane, 1,3-dioxepane and 1,3,6-trioxocane as cyclic ethers as well as linear oligo- or polyformales, like polydioxolane or polydioxepane.

Further, functionalized polyoxymethylenes which are prepared by copolymerization of trioxane and the formal of trimethylolpropane (ester), of trioxane and the alpha, alpha and the alpha, beta-isomers of glyceryl formal (ester) or of trioxane and the formal of 1,2,6-hexantriol (ester) can be used as polyoxymethylene.

The amount of polyoxymethylene polymer present in the polymer article can vary depending upon the particular application. In one embodiment, for instance, the article contains polyoxymethylene polymer in an amount of at least 50% by weight, such as in an amount greater than about 55% by weight, such as in an amount greater than about 60% by weight, such as in an amount greater than about 65% by weight. In general, the polyoxymethylene polymer is present in the article in an amount up to 100% by weight, and in some embodiments, less than about 99% by weight, such as in an amount less than about 95% by weight, such as in an amount less than about 90% by weight.

In one embodiment, the polyoxymethylene polymer may be combined with a thermoplastic elastomer and optionally a coupling agent. The coupling agent couples the thermoplastic elastomer to the polyoxymethylene polymer. In one embodiment, a covalent bond is formed.

Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE-E), thermoplastic polyamide elastomers (TPE-A) and in particular thermoplastic polyurethane elastomers (TPE-U). The above thermoplastic elastomers have active hydrogen atoms which can be reacted with coupling reagents and/or the polyoxymethylene polymer. Examples of such groups are urethane groups, amido groups, amino groups or hydroxyl groups. For instance, terminal polyester diol flexible segments of thermoplastic polyurethane elastomers have hydrogen atoms which can react, for example, with isocyanate groups.

In one particular embodiment, a thermoplastic polyurethane elastomer is used. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as poly(butylene adipate)diol, poly(ethylene adipate)diol and poly(E-caprolactone)diol; and polyether diols such as poly(tetramethylene ether)glycol, poly(propylene oxide)glycol and poly(ethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

In one particular embodiment, a thermoplastic polyurethane elastomer is used that contains carbonate groups. The thermoplastic polyurethane elastomer, for instance, may have at least one soft segment containing carbonate groups.

Thermoplastic elastomers containing carbonate groups can be produced, in one embodiment, using a diol component that contains carbonate groups. For instance, the thermoplastic elastomer can be produced as described above by reacting together a polymer diol containing carbonate groups with an isocyanate and a chain extender. The polymer dial, for instance, may comprise a polycarbonate diol and/or a polyester polycarbonate diol.

A polycarbonate diol may be produced by reacting a diol with a carbonate compound. The carbonate compound may comprise, for instance, a carbonate compound with alkyl groups, a carbonate compound with alkylene groups, or a carbonate compound containing aryl groups. Particular carbonate compounds include dimethyl carbonate, diethyl carbonate, ethylene carbonate, and/or diphenyl carbonate. A polyester polycarbonate, on the other hand, may be formed by reacting a diol with a carbonate compound as described above in the presence of a carboxylic acid.

As described above, the polycarbonate groups contained in the thermoplastic elastomer are generally referred to as soft segments. Thus, the polycarbonate groups have a tendency to lower the hardness of the thermoplastic elastomer. In one embodiment, for instance, the Shore A hardness of the thermoplastic elastomer is less than about 98, such as less than about 95, such as less than about 93 when tested according to ISO Test 868. The shore A hardness of the material is generally greater than about 80, such as greater than about 85.

The amount of thermoplastic elastomer contained in the polymer composition can vary depending upon various factors. In general, the thermoplastic elastomer is present in an amount greater than about 5% by weight, such as in an amount greater than about 10% by weight, such as in an amount greater than about 15% by weight, such as in an amount greater than about 20% by weight, such as in an amount greater than about 25% by weight. In general, the thermoplastic elastomer is present in amounts less than about 50% by weight, such as less than about 40% by weight, such as less than about 30% by weight.

In one embodiment, the thermoplastic elastomer may be coupled to the polyoxymethylene polymer of the present disclosure via the coupling agent as described above. The coupling agent can form bridging groups between the polyoxymethylene polymer and the thermoplastic elastomer. Further, the coupling agent may be capable of forming covalent bonds with the terminal hydroxyl groups on the polyoxymethylene polymer and with active hydrogen atoms on the thermoplastic elastomer. In this manner, the thermoplastic elastomer becomes coupled to the polyoxymethylene through covalent bonds.

When a thermoplastic elastomer is included in the composition of the present disclosure, the poloxymethylene polymer, thermoplastic elastomer, and coupling agent can be melt blended in an extruder, and then various loadings of texturizing agents, such as glass fibers, can be added.

A wide range of polyfunctional, such as trifunctional or bifunctional coupling agents, may be used. In one embodiment, the coupling agent comprises a diisocyanate, such as an aliphatic, cycloaliphatic and/or aromatic diisocyanate. The coupling agent may be in the form of an oligomer, such as a trimer or a dimer.

In one embodiment, the coupling agent comprises a diisocyanate or a triisocyanate which is selected from 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPM); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-dilsocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3, 3, 5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1₇3-bis (isocyanato-methy)cyclohexane, 1,6-diisocyanato-2,2,4,4-tetra-methylhexane, 1,6-dilsocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic polyisocyanate is used, such as 4,4′-diphenylmethane diisocyanate (MDI).

The polymer composition generally contains the coupling agent in an amount from about 0.1% to about 10% by weight. In one embodiment, for instance, the coupling agent is present in an amount greater than about 1% by weight, such as in an amount greater than 2% by weight. In one particular embodiment, the coupling agent is present in an amount from about 0.2% to about 5% by weight. To ensure that the thermoplastic elastomer has been completely coupled to the polyoxymethylene polymer, in one embodiment, the coupling agent can be added to the polymer composition in molar excess amounts when comparing the reactive groups on the coupling agent with the amount of terminal hydroxyl groups on the polyoxymethylene polymer.

The polymer composition containing the polyoxymethylene polymer used to form the molded article may contain various additives. Such additives can include, for example, antioxidants, acid scavengers, UV stabilizers or heat stabilizers. In addition, the molding material or the molding may contain processing auxiliaries, for example adhesion promoters, lubricants, nucleating agents, demolding agents, fillers, reinforcing materials or antistatic agents and additives which impart a desired property to the molding material or to the molding.

For instance, in one embodiment, an ultraviolet light stabilizer may be present. The ultraviolet light stabilizer may comprise a benzophenone, a benzotriazole, or a benzoate. Particular examples of ultraviolet light stabilizers include 2,4-dihydroxy benzophenone, 2-hydroxy-4-methoxybenzophenone, 2-(2′-hydroxy-3′,5′-di-t-butylphenyl)benzotriazole, 2-(2′-hydroxy-3′-t-butyl-5′-methylphenyl)-5-chlorobenzotriazole, 2,4-dihydroxybenzophenone, 2-hydroxy-4-methoxybenzophenone, 2-hydroxy-4-octoxybenzophenone, and 5,5-methylene bis(2-hydroxy-4-methoxybenzophenone); 2-(2′-hydroxyphenyl)benzotriazoles, e.g., 2-(2′-hydroxy-5′-methylphenyl)benzotriazole, 2-(2′-hydroxy-5′-t-octylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′-t-butyl-5′-methylphenyl)-5-chlorobenzotriazole, 2-(2′-hydroxy-3′,5′-dicumylphenyl)benzotriazole, and 2,2′-methylene bis(4-t-octyl-6-benzotriazolyl)phenol, phenylsalicylate, resorcinol monobenzoate, 2,4-di-t-butylphenyl-3′,5′-di-t-butyl-4′-hydroxybenzoate, and hexadecyl-3,5-di-t-butyl-4-hydroxybenzoate; substituted oxanilides, e.g., 2-ethyl-2′-ethoxyoxanilide and 2-ethoxy-4′-dodecyloxanilide; cyanoacrylates, e.g., ethyl-α-cyano-β,β-diphenylacrylate and methyl-2-cyano-3-methyl-3-(p-methoxyphenyl)acrylate, or mixtures thereof.

In one embodiment, the polymer composition may also include a formaldehyde scavenger, such as a nitrogen-containing compound. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Advantageous compounds of this nature are aminopyridine and compounds derived therefrom. Any of the aminopyridines is in principle suitable, for example 2,6-diaminopyridine, substituted and dimeric aminopyridines, and mixtures prepared from these compounds. Other advantageous materials are polyamides and dicyane diamide, urea and its derivatives and also pyrrolidone and compounds derived therefrom. Examples of suitable pyrrolidones are imidazolidinone and compounds derived therefrom, such as hydantoines, derivatives of which are particularly advantageous, and those particularly advantageous among these compounds are allantoin and its derivatives. Other particularly advantageous compounds are triamino-1,3,5-triazine (melamine) and its derivatives, such as melamine-formaldehyde condensates and methylol melamine. Oligomeric polyamides are also suitable in principle for use as formaldehyde scavengers. The formaldehyde scavenger may be used individually or in combination.

Further, the formaldehyde scavenger can be a guanidine compound which can include an aliphatic guanamine-based compound, an alicyclic guanamine-based compound, an aromatic guanamine-based compound, a hetero atom-containing guanamine-based compound, or the like. The formaldehyde scavenger can pe present in the composition in an amount less than about 2% by weight, such as an amount from about 0.001% by weight to about 1.5% by weight, such as from about 0.01% by weight to about 1% by weight.

In one embodiment, the composition may also contain a nucleant. The nucleant, for instance, may increase crystallinity and may comprise an oxymethylene terpolymer. In one particular embodiment, for instance, the nucelant may comprise a terpolymer of butanediol diglycidyl ether, ethylene oxide, and trioxane. The nucleant can be present in the composition in an amount greater than about 0.05% by weight, such as greater than about 0.1% by weight. The nucleant may also be present in the composition in an amount less than about 2% by weight, such as in an amount less than about 1% by weight.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (IRGANOX® 1010, BASF), triethylene glycol bis[3-(3-tert-butyl-4-hydroxy-5-methylphenyl)propionate] (IRGANOX® 245, BASF), 3,3′-bis[3-(3,5-di-tert-butyl-4-hydroxyphenyl)propionohydrazide] (IRGANOX® MD 1024, BASF), hexamethylene glycol bis[3-(3,5-di-tert-butyl-4-hydroxyphenyl)propionate] (IRGANOX® 259, BASF), and 3,5-di-tert-butyl-4-hydroxytoluene (LOWINOX® BHT, Chemtura). Preference is given to IRGANOX® 1010 and especially IRGANOX® 245. The above compounds may be present in the composition in an amount less than about 2% by weight, such as in an amount from about 0.01% to about 1% by weight.

Light stabilizers that may be present in addition to the ultraviolet light stabilizer in the composition include sterically hindered amines. Hindered amine light stabilizers that may be used include oligomeric compounds that are N-methylated. For instance, another example of a hindered amine light stabilizer comprises ADK STAB LA-63 light stabilizer available from Adeka Palmarole. The light stabilizers, when present, can be included in amounts greater than about 0.1% by weight, such as in amounts greater than about 0.5% by weight, but in an amount less than about 2% by weight, such as in an amount less than about 1% by weight.

In one embodiment, the composition may also contain one or more lubricants. The lubricant may comprise a polymer wax composition. Lubricants that may be included in the composition include, for instance, N,N′-ethylene bisstearamide (EBS). In one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. Lubricants can generally be present in the polymer composition in an amount from about 0.01% to about 5% by weight. For instance, a lubricant can be present in an amount greater than about 0.1% by weight, such as in an amount from about 0.1% to about 1% by weight. The above polyethylene glycol polymer can also be present in an amount up to about 5% by weight. For instance, the polyethylene glycol polymer can be present in an amount from about 0.1% to about 2% by weight, such as from about 0.5% to about 1% by weight.

In addition to the above components, the polymer composition may also contain an acid scavenger. The acid scavenger may comprise, for instance, an alkaline earth metal salt. For instance, the acid scavenger may comprise a calcium salt, such as a calcium citrate. The acid scavenger may be present in an amount of from about 0.01% to about 1% by weight.

Any of the above additives can be added to the polymer composition alone or combined with other additives. In general, each additive is present in an amount less than about 5% by weight, such as in an amount less than about 2% by weight, such as in an amount less than about 1% by weight.

An almost limitless variety of polymer articles may be molded in accordance with the present disclosure. Such articles may include knobs, door handles, automotive panels, interior automotive parts such as bezels, consumer appliance parts, and the like without limitation.

Molded articles can be made according to the present disclosure using various different processes. In one embodiment, for instance, the molded articles can be formed through an injection molding process where molten polymer is injected into a heated mold. In an alternative embodiment, the articles may be formed through a blow molding process. Other embodiments include rotational molding and extrusion. Generally, the heated mold temperature for polyoxymethylene is less than about 125° C., such as from about 60° C. to about 120° C., such as from about 65° C. to about 110° C., such as from about 70° C. to about 100° C.

After the polymer composition has been molded, the polymer substrate is subjected to the coating process of the present disclosure in order to impart color to the molded article.

In accordance with the present disclosure, a primer coat and optionally a base coat and/or clear coat are applied to the surface of the molded substrate. The coatings can cover the entire surface of the substrate or only a portion of the surface of the substrate. The primer coat and the base coat generally contain an adhesive agent, optionally one or more pigments, optionally a dispersant, optionally a leveling agent, and a curing agent. The primer coat composition and the base coat composition applied to the substrate also can contain a solvent.

In one embodiment, the adhesive agent comprises an acrylic polyol. The same or different acrylic polyols may be contained in the primer coat and base coat. As used herein, an acrylic polyol also refers to a cured polymer formed from one or more acrylic or acrylate monomers. An acrylic polyol as used herein has more than one hydroxy group per molecule. In one embodiment, the acrylic polyol is a copolymer that is polymerized from a monomer composition that contains at least one C₈ or higher alkyl acrylate monomer. The acrylic polyol can have a weight average molecular weight in the range from about 2,000 to about 200,000, such as from about 10,000 to about 50,000.

Suitable C₈ or higher alkyl acrylate monomers include monomers of formula:

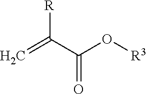

wherein R is H or CH₃ and R³ is a linear or branched alkyl having 8 or more carbons. Preferably, R³ has more than 10 carbons and more preferably, R³ has more than 12 carbons. R³ is not particularly limited as to an upper limit of carbon atoms. However, at greater than 30 carbons, the monomers tend to be solids which are harder to handle in production and the T_{g} of polymers produced using these monomers tends to be too low to make a suitable coating.

Examples of suitable linear or branched C8 or higher alkyl acrylate monomers include octyl acrylate, octyl methacrylate, nonyl acrylate, nonyl methacrylate, decyl acrylate, decyl methacrylate, undecyl acrylate, undecyl methacrylate, dodecyl acrylate, dodecyl methacrylate, isodecyl acrylate, isodecyl methacrylate, isotridecyl acrylate, isotridecyl methacrylate, tridecyl acrylate, tridecyl methacrylate, tridecyl acrylate, tridecyl methacrylate, lauryl acrylate, lauryl methacrylate, stearyl acrylate, and stearyl methacrylate. Combinations thereof are also useful.

In one embodiment, the acrylic resin used in the present disclosure is sold under the tradename ACRYDIC by the DIC Corporation.

The monomers used to form the acrylic polyol, in one embodiment, may contain a polyester-extended acrylate monomer. In one embodiment, however, the monomer mixture may be free of a polyester-extended acrylate monomer meaning that no polyester-extended acrylate monomers are present.

As stated above, the primer coat and base coat may optionally also contain one or more pigments. No particular limitation is imposed on the pigment, and examples thereof include organic pigments and inorganic pigments, such as extender pigments, white pigments, black pigments, gray pigments, red pigments, brown pigments, green pigments, blue pigments, violet pigments, metallic powder pigments, fluorescent pigments and pearlescent pigments, and plastic pigments, each described in “Coating Material Handbook, 1970 (ed. by Japan Paint Manufacturers Association). Various colorants can be given as examples of the colorant. The organic pigments include, for example, insoluble azo pigments such as Benzidine Yellow, Hansa Yellow and Lake Red 4R; soluble azo pigments such as Lake Red C, Carmine 6B and Bordeaux 10; (copper) phthalocyanine pigments such as Phthalocyanine Blue and Phthalocyanine Green; basic dye lakes such as Rhodamine Lake and Methyl Violet Lake; mordant dye type pigments such as Quinoline Lake and Fast Sky Blue; vat dye type pigments such as anthraquinone pigments, thioindigo pigments and perinone pigments; quinacridone pigments such as Cinquasia Red B; dioxazine pigments such as Dioxazine Violet; condensed azo pigments such as chromophthal pigments and aniline black.

Examples of the inorganic pigment include chromates such as Chrome Yellow, Zinc Chromate and Molybdate Orange; ferrocyanide compounds such as iron blue pigments; metal oxides such as Titanium Oxide, Zinc Oxide, Mapico Yellow, Iron Oxide, Red Oxide and Chrome Oxide Green; sulfides or selenides such as Cadmium Yellow, Cadmium Red and Mercury Sulfide; sulfates such as Barium Sulfate and Lead Sulfate; silicates such as Calcium Silicate and Ultramarine Blue; carbonates such as Calcium Carbonate and Magnesium Carbonate; phosphates such as Cobalt Violet and Manganese Violet; metallic powder pigments such as aluminum powder, gold powder, silver powder, copper powder, bronze powder and brass powder; flake pigments or mica flake pigments of these metals; metallic pigments or pearlescent pigments such as mica flake pigments covered with a metal oxide and mica-state iron oxide pigments; and graphite and carbon black.

Examples of the extender pigment include precipitated barium sulfate, gohun, precipitated calcium carbonate, calcium bicarbonate, white (Japanese) marble, alumina white, silica, hydrous fine silica particles (white carbon), anhydrous ultrafine silica particles (aerosil), silica sand, talc, precipitated magnesium carbonate, bentonite, clay, kaolin and Chinese Yellow.

In one embodiment, for instance, the base coat may contain a pigment such as bismuth yellow pigment.

In one embodiment, at least one dispersant may also be contained in the primer coat and/or base coat. For instance, the dispersant may comprise a pigment dispersant. One example of a pigment dispersant is an acrylic block copolymer.

The coatings may also contain a leveling agent, such as a fluorocarboned acrylate.

The primer coat and base coat also include a curing agent for the adhesive agent. The curing agent may comprise an aminoplast resin, a melamine, a polyisocyanate, or a combination thereof. In one embodiment, a polyisocyanate may be used which may comprise one of the isocyanates described above with respect to the coupling agent. Typical examples of polyisocyanates are isocyanate compounds having 2 to 4 isocyanate groups per molecule, such as 1,6-hexamethylene diisocyanate, isophorone diisocyanate, 2,4-toluene diisocyanate, diphenylmethane-4,4′-diisocyanate, dicyclohexylmethane-4,4′-diisocyanate, tetramethylxylidene diisocyanate, and the like. Polyisocyanate condensation products can also be used. Polyisocyanates having isocyanurate, biuret, iminooxadiazine, and/or uretidione structural units are suitable.

The primer coat and base coat composition applied to the polymer substrate may also contain a solvent. The solvent may comprise an organic solvent selected from aromatic hydrocarbons, such as petroleum naphtha or xylenes; ketones, such as, methyl amyl ketone, methyl isobutyl ketone, methyl ethyl ketone or acetone; esters, such as, butyl acetate or hexyl acetate; glycol ether esters, such as propylene glycol monomethyl ether acetate; and combination thereof.

In one embodiment, the primer coat can contain an adhesive agent comprising one or more acrylic polyols. In accordance with the present disclosure, the primer coat may also contain a coadhesion agent. The coadhesion agent may be present in the primer coat in order to further improve adhesion between the polyoxymethylene polymer and the coating. In one embodiment, the coadhesion agent may comprise a copolyester. For example, the adhesion agent may comprise a copolyester of terephthalic acid and isophthalic acid. The coadhesion agent may be present in the primer coat composition in an amount from about 3% to about 25% by weight, such as in an amount from about 5% to about 15% by weight. The coadhesion agent may be present in the dried primer coating in an amount from about 3% to about 30% by weight, such as in an amount from about 5% to about 20% by weight.

In one embodiment, the primer coat is formed from a primer slurry. The primer slurry, in one embodiment, can contain one or more adhesive agents in an amount from about 30% to about 60% by weight, such as in an amount from about 45% to about 55% by weight. The primer slurry may also contain one or more pigments and fillers. In one particular embodiment, for instance, in order to provide color tuning, the primer slurry contains carbon black, titanium dioxide, talc and kaolin. The carbon black can be present in an amount from about 0.05% to about 1% by weight. The titanium dioxide can be present in an amount from about 15% to about 25% by weight, while the talc can be present in an amount from about 2% to about 10% by weight. The talc is optional and can be used to increase hardness and abrasion resistance. Kaolin may be present in an amount from about 5% to about 15% by weight and can be used as a filler and as a colorant. The kaolin may, however, be replaced with titanium dioxide or zinc sulfate. The primer slurry may also contain a pigment dispersant, such as an acrylic block copolymer.

The primer slurry further contains a solvent such as a combination of butyl acetate and xylene. The solvent may be present in an amount from about 10% to about 20% by weight.

Once formulated, the primer slurry is ground to reach a desired fineness. In one embodiment, for instance, the primer slurry is ground such that at least 90% of all of the particles contained in the slurry have an average particle size of less than 20 microns. Particle size distribution can be measured using ISO Test 1524 or ASTM Test D 1210. Particle size can be determined using a Hegman gauge.

The primer slurry is then combined with the coadhesion agent, more adhesion agent, a leveling agent, greater amounts of the solvent, and a curing agent. In one embodiment, for instance, the primer coat composition contains the coadhesion agent in an amount from about 5% to about 15% by weight, contains the primer slurry in an amount from about 40% to about 65% by weight, such as in an amount from about 50% to about 65% by weight. The primer coat composition can further contain greater amounts of the adhesive agent such as adding an additional 15% by weight, such as an additional 20% by weight. Additional solvent can be added in an amount from about 15% to about 25% by weight. The primer coat composition can further contain a leveling agent in an amount from about 0.05% to about 1% by weight and a curing agent in an amount from about 2% to about 8% by weight, such as in an amount from about 3% to about 5% by weight.

The primer coat composition is applied directly onto the surface of the polymer substrate. In one embodiment, the coadhesion agent is first applied to the polymer substrate and heated to a temperature of from about 100° C. to about 200° C., such as from about 120° C. to about 140° C. for one to 30 minutes. The primer coat composition is then applied and heated at a temperature of from about 50° C. to about 200° C., such as at a temperature of from about 60° C. to about 80° C. for a time of from about one minute to about two hours, such as from about 10 minutes to about one hour. If desired, the primer coat composition can be heated again at the same temperatures for one to three hours in order to ensure that the coating is adhered to the polymer substrate and completely cured prior to applying the base coat composition.

The dried primer coat can contain the adhesive agent in an amount from about 40% to about 80% by weight, such as in an amount from about 50% to about 70% by weight. The one or more pigments and fillers can be present in the dried primer coat in an amount from about 5% to about 30% by weight, such as in an amount from about 5% to about 25% by weight.

In one embodiment, the base coat contains the adhesive agent in an amount from about 30% to about 60% by weight, such as from about 40% to about 55% by weight. When the base coat is used to provide color, a pigment may be contained in the base coat composition in an amount greater than 3% by weight, such as in an amount greater than 5% by weight, such as in an amount greater than 7% by weight. For instance, the pigment may be present in an amount from about 3% to about 20% by weight. The dispersant for the pigment is generally present in an amount from about 0.01% to less than 2% by weight, such as from about 0.1% to about 1% by weight. When present, the leveling agent is contained in the base coat composition in an amount from about 0.01% to about 2% by weight, such as from about 0.05% to about 1% by weight. The curing agent may be present in the base coat composition in an amount from about 0.5% to about 20% by weight, such as from about 1% to about 10% by weight, and particularly from about 1% to about 6% by weight. The solvent, on the other hand, may comprise a combination of xylene and butyl acetate. The xylene and butyl acetate may be present at a ratio of about 1:1. The solvent may be present in the coating composition in an amount greater than 20% by weight, such as in an amount greater than 30% by weight, and generally less than about 70% by weight, such as less than 60% by weight. In one embodiment, the solvent is present in the coating composition in an amount from about 40% to about 50% by weight.

In one embodiment, the base coat composition may be prepared in a manner that controls the particle sizes of the pigments present in the composition. For instance, in one embodiment, a base slurry may first be formed. The base slurry may contain the pigment particles, a portion of the adhesive agent, the pigment dispersant, and some of the solvent. For instance, in one embodiment, a base slurry is first formulated that contains the pigment in an amount greater than 40% by weight, such as in an amount from about 40% to about 80% by weight. Added to the pigment is the adhesive agent in an amount from about 15% to about 30% by weight and a solvent in an amount from about 5% to about 20% by weight. The slurry is ground in order to ensure that no large particles remain. For instance, in one embodiment, the slurry is ground such that greater than 90% of the pigment particles have an average particle size of less than 10 microns.

Once the slurry is ground, the slurry can then be combined with greater amounts of the adhesive agent, greater amounts of the solvent, optionally a leveling agent, and the curing agent to produce the base coat composition as described above.

Once the base coat composition is formulated, the composition can be applied to a surface of the molded substrate. In one embodiment, for instance, the base coat can be sprayed onto a surface of the molded substrate. Once sprayed onto the substrate, the substrate can be heated to a temperature of from about 50° C. to about 200° C., such as at a temperature of from about 60° C. to about 80° C. for a time sufficient for the coating to cure. For instance, the base coat may be heated to the above temperatures for a time of from about 5 minutes to about one hour. The resulting coating can form a film and can have a thickness of from about 10 microns to about 50 microns, such as from about 15 microns to about 30 microns. In one embodiment, the base coat can be sprayed and cured on the substrate multiple times.

The resulting dried coating generally contains the adhesive agent in an amount greater than 40% by weight, such as in an amount greater than 45% by weight, such as in an amount greater than about 50% by weight, such as in an amount greater than 55% by weight. The adhesive agent is present in the dried coating in an amount generally less than 90% by weight, such as in an amount less than about 80% by weight. The above weight percentages refer to all of the adhesive agents present in the dried base coat. For instance, the base coat may contain a single adhesive agent or a plurality of adhesive agents.

The pigment is contained in the dried base coat in an amount greater than about 3% by weight, such as in an amount greater than about 5% by weight. The pigment may be present in an amount from about 5% to about 20% by weight, such as in an amount from about 5% to about 15% by weight. The dispersant and leveling agent are contained in the dried base coat generally in an amount less than 2% by weight, such as in an amount less than 1% by weight. The curing agent is present in the dried base coat in an amount of from about 2% to about 12% by weight, such as in an amount from about 5% to about 10% by weight.

As described above, in one embodiment, the base coat can be sprayed onto a surface of the polymer substrate. In other embodiments, however, the primer coat composition and/or the base coat composition may be applied by roller coating, dipping, brushing, printing, and the like. Using each of the above methods, the coating compositions may be applied in a single coat or may be applied as multiple coats.

After the primer coat and optionally a base coat is applied to a surface of the polymer substrate and cured, a clear coat can be applied over the base coat. The clear coat can be applied as a two-component system. The first component may contain one or more adhesive agents, a leveling agent, a catalyst, and a solvent. The second component, on the other hand, may comprise a curing agent in combination with a solvent. In accordance with the present disclosure, the adhesive agent contained in the first component may comprise an acrylic polyol as described above. In one preferred embodiment, for instance, the first component may contain a combination of acrylic polyols. The adhesive agent may be present in the first component in an amount greater than about 60% by weight, such as in an amount from about 70% to about 95% by weight.

As described above, the first component may also contain a leveling agent, such as a polydimethylsiloxane. The leveling agent is generally present in an amount from about 0.05% to about 2% by weight.

A catalyst can also be present in the first component that increases cure times. In one embodiment, a tin catalyst may be used. The catalyst may be present in the first component in an amount from about 0.5% to about 4% by weight, such as from about 1% to about 3% by weight.

The first component can also contain a solvent such as the solvents described above. The solvent may be present in an amount from about 5% to about 15% by weight.

The second component of the clear coat composition contains a curing agent as described above in combination with a solvent. The curing agent and the solvent can be present in the second component at a weight ratio of from about 6:1 to about 1:1. For instance, the weight ratio can be from about 4:1 to about 2:1.

The first component and the second component are combined together and applied over the base coat on the polymer substrate. The first component can be blended with the second component at a weight ratio of from about 5:1 to about 1:1, such as from about 3:1 to about 2:1. The clear coat can be applied using any of the application techniques described above to a surface of the substrate and heated in order to cure the coating. In one embodiment, the clear coat composition is applied twice to the surface of the substrate and cured at a temperature of from about 50° C. to about 200° C., such as from about 60° C. to about 80° C. for a time of from about 30 minutes to about 3 hours.

The resulting clear coat is generally transparent and contains no pigments. The dried clear coat contains the one or more adhesive agents in an amount greater than about 60% by weight, such as in an amount greater than 65% by weight, such as in an amount greater than 70% by weight, such as in an amount greater than about 75% by weight. The one or more adhesive agents is generally present in an amount less than 95% by weight, such as in an amount less than 90% by weight.

In an alternative embodiment, the clear coat may include a curing agent that allows the clear coat to be cured using ultraviolet light. In one embodiment, for instance, the clear coat may contain one or more adhesive agents in an amount from about 10% to about 50% by weight in combination with a UV curable polyurethane dispersion. The polyurethane dispersion may be present in the composition in an amount from about 50% to about 70% by weight, such as in an amount from about 55% to about 65% by weight. The clear coat composition, in this embodiment, may further contain one or more photoinitiators. The photoinitiator may comprise an acrylate in combination with mono or multifunctional monomers. The photoinitiator, for instance, may comprise 1-hydroxy-cyclohexyl-phenyl-ketone and/or a benzophenone. The composition may further contain one or more additives, such as a viscosity stabilizer. The additives may be present in an amount less than about 2% by weight, such as from about 0.1% to about 2% by weight.

The above composition can be cured using ultraviolet light, such as in an amount of about 80 W/cm. When the clear coat is ultraviolet light curable, the primer coat and/or the base coat formulations may be modified and adjusted in order to match cohesion with the clear coat.

As described above, the coating system of the present disclosure may have different purposes when applied to a molded article made from a polyoxymethylene polymer. In one embodiment, for instance, the coating system may be used in order to provide color to the article. In addition to or instead of providing color, however, one or more coatings of the present disclosure may also be applied to a molded article for a more functional purpose. In one embodiment, for instance, the coating system may be applied to a molded article for providing resistance to ultraviolet light. In this embodiment, the primer layer, the base coat, and/or the clear coat may contain one or more light stabilizers such as the light stabilizers described above.

In an alternative embodiment, the coating system may be used to provide scuff and/or abrasion resistance. In one embodiment, for instance, only the primer coat is applied to the molded article.

In still another embodiment, the coating system may be used to provide anti-glare properties and/or anti-reflective properties. In this embodiment, the primer coat alone or in combination with the other coatings may be used. In order to provide anti-glare and/or anti-reflective properties, various particles may be incorporated into the one or more coatings. For example, metal oxide particles may be used to provide the anti-glare or anti-reflective properties. Such particles include silica particles.

As described above, the coating system of the present disclosure displays excellent adherence properties to the surface of a polyoxymethylene polymer. The resulting coating is strong, durable and scratch resistant.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A molded article comprising:
a molded substrate comprising a polyoxymethylene polymer, the molded substrate having a surface;
a primer coat applied to the surface of the molded substrate, the primer coat including an adhesive agent and a coadhesion agent;
optionally a base coat applied to the primer coat, the base coat comprising an adhesive agent, optionally one or more pigments, optionally a dispersant, and a curing agent; and
optionally a clear coat covering the base coat or primer coat and comprising an exterior surface of the molded article.

2. A molded article as defined in claim 1, wherein the adhesive agent contained in the primer coat and the adhesive agent contained in the base coat both comprise acrylic polyols,

3. A molded article as defined in claim 2, wherein the primer coat contains one or more pigments.

4. A molded article as defined in claim 3, wherein the coadhesive agent comprises a copolyester.

5. A molded article as defined in claim 2, wherein the primer coat further comprises a curing agent.

6. A molded article as defined in claim 2, wherein the primer coat further comprises a filler, a pigment dispersant, and a leveling agent and wherein the pigment and the filler comprise particles and wherein at least 90% of the particles have an average particle size of less than 20 microns.

7. A molded article as defined in claim 2, wherein the primer coat is applied directly to the surface of the molded substrate.

8. A molded article as defined in claim 1, wherein the adhesive agent contained in the base coat comprises an acrylic polyol.

9. A molded article as defined in claim 1, wherein the base coat further comprises a pigment dispersant and a leveling agent.

10. A molded article as defined in claim 9, wherein the pigment dispersant comprises an acrylic block copolymer.

11. A molded article as defined in claim 1, wherein at least one or more pigments are contained in the base coat in an amount of at least about 5% by weight, and wherein the amount is less than about 25%.

12. A molded article as defined in claim 9, wherein the leveling agent comprises a fluorocarboned acrylate.

13. A molded article as defined in claim 1, wherein the curing agent contained in the base coat comprises an isocyanate.

14. A molded article as defined in claim 1, wherein the adhesive agent is present in the base coat in an amount from about 50% to about 90% by weight, the pigment is present in the base coat in an amount from about 5% to about 20% by weight, a pigment dispersant is present in the base coat in an amount from 0.1% to 2% by weight, and a leveling agent is present in the base coat in an amount from about 0.05% to about 2% by weight.

15. A molded article as defined in claim 1, wherein the clear coat comprises at least one adhesive agent and a curing agent, the clear coat being free of any pigments.

16. A molded article as defined in claim 1, wherein an acrylic polyol is contained in the base coat and an acrylic polyol is also contained in the clear coat.

17. A process for painting a molded article comprising:
applying to a surface of a polymer substrate a primer coat and then a base coat, the primer coat and the base coat comprising an adhesive agent, one or more pigments, a dispersant, and a curing agent; and
applying a clear coat covering the base coat and comprising an exterior surface of the molded article.

18. A process as defined in claim 17, wherein the primer coat includes a coadhesive agent.

19. A process as defined in claim 17, wherein the base coat is formed on the molded article by applying a base coat composition to a surface of the molded substrate, the base coat composition being formed from a base coat slurry, the base coat slurry comprising the one or more pigments and the adhesive agent being combined together with a solvent and ground such that at least 90% of the particles contained in the slurry have an average particle size of less than 10 microns, the base coat slurry then being combined with greater amounts of the adhesive agent and solvent in addition to being combined with the curing agent, the resulting base coat composition being sprayed onto the surface of the molded substrate.

20. A process as defined in claim 18, wherein the primer coat, the base coat, and the clear coat all contain an acrylic polyol.
